(19) United States
(12) Patent Application Publication
(10) Pub. No.: US 2025/0162946 A1
(43) Pub. Date: May 22, 2025

(54) SYNERGISTIC MECHANISM FOR ENHANCED FIRE PROTECTION

(71) Applicant: GP Building Products Services LLC, Atlanta, GA (US)

(72) Inventors: Allison Nicole Goins, Decatur, GA (US); Hamed Mustafa Kayello, Peachtree Corners, GA (US); Sudhanshu Srivastava, Decatur, GA (US); Vincent B. Thomas, Bogart, GA (US); Siddartha Thota, Decatur, GA (US)

(21) Appl. No.: 18/841,405

(22) PCT Filed: Jan. 3, 2024
(86) PCT No.: PCT/IB2024/050044

§ 371 Date: Aug. 26, 2024

Related U.S. Application Data
(60) Provisional application No. 63/438,038, filed on Jan. 10, 2023.

(51) Int. Cl. C04B 28/14; C04B 14/02; C04B 14/04; C04B 111/00; C04B 111/28; C04B 111/34

(52) U.S. Cl. CPC C04B 28/14; C04B 14/024; C04B 14/045; C04B 2111/00413; C04B 2111/0062; C04B 2111/285; C04B 2111/343

(57) ABSTRACT

Gypsum panels exhibiting improved fire-resistance properties are provided. The gypsum panels comprise a first additive package, having intumescent properties, and a second additive package, exhibiting structural integrity at high temperatures. Methods of making such gypsum panels, and compositions used to prepare such gypsum panels are also provided.

### RELATED APPLICATION

This application claims priority to U.S. Provisional Application No. 63/438,038, filed on Jan. 10, 2023, which is incorporated by reference herein in its entirety.

### BACKGROUND

The present invention relates generally to the field of panels for use in building construction, and more particularly to gypsum panels and methods of making gypsum panels.

Gypsum panels (also known as drywall panels) are a commonly used building material. As such, the gypsum panels are typically required to have a certain degree of fire resistance.

During full-scale fire tests, there are three primary modes of failure (thermal transmission, shrinkage, and structural stability) after exposure to heat. Traditionally, vermiculite (U.S. Pat. No. 3,376,147) is used by the industry to mitigate these modes of failure. However, supply constraints with the appropriate grade of vermiculite have become an issue. Accordingly, there is a need to find alternatives. The typical approach to this is using materials to supplement the amount of vermiculite that is needed in the core of the board. Materials such as perlite, expandable graphite, and other sheet silicates that expand when heated have been used in combination with vermiculite in gypsum manufacturing to try to directly mimic the mechanism of fire protection of vermiculite. However, it would be desirable to obtain gypsum panels with improved resistance to more than one failure mode that do not contain any vermiculite, and have enhanced fire performance.

It is with this, and other improvements, in mind that the following invention is described.

### BRIEF SUMMARY

Gypsum panels exhibiting improved fire resistance, due to the presence of a first additive package, having intumescent properties, and a second additive package, exhibiting structural integrity at high temperatures, are provided.

An embodiment of the invention is a composition comprising:
a) calcium sulfate dihydrate;
b) a first additive package that expands when heated from a first temperature to a second temperature; wherein the second temperature is greater than the first temperature; wherein the first temperature is ≥100° C.; and wherein the second temperature is ≤1100° C.; and
c) a second additive package that improves the structural stability of the composition when exposed to a temperature≥800° C. compared to a control composition containing calcium sulfate dihydrate and the first additive package having an identical calcium sulfate dihydrate:first additive package weight ratio but without the second additive package.

An embodiment is a gypsum panel comprising:
a) calcium sulfate dihydrate;
b) a first additive package comprising at least one selected from expandable graphite and hydrated sodium alkali metal metasilicate;
c) a second additive package comprising at least 40 wt. % of one silica-containing mineral; and 0-5 wt. % of a ceramic flux agent.

An embodiment is a gypsum panel comprising one of the above-identified compositions, wherein the gypsum panel comprises a less-dense core layer and at least one more dense slate coat layer.

An embodiment is also a method of making a gypsum panel, comprising:
i) providing from one to three gypsum slurries, each comprising water and a composition as described above;
ii) setting the one to three gypsum slurries on a first face layer to form one to three gypsum layers of the gypsum panel; and
iii) setting a second face layer on top of the one to three gypsum layers.

### BRIEF DESCRIPTION OF THE SEVERAL VIEWS OF THE DRAWING(S)

Having thus described the subject matter in general terms, reference will now be made to the accompanying drawings, which are not necessarily drawn to scale.

FIG. 1A is an exemplary diagram of a gypsum panel cross section comprising two slate coat layers.

FIG. 1B is an exemplary diagram of a gypsum panel cross section comprising one slate coat layer.

FIG. 1C is an exemplary diagram of a gypsum panel cross section lacking a slate coat layer.

FIG. 2 is a portion of ASTM E119, showing a time-temperature curve used in the Examples.

FIG. 3 is a schematic of the gypsum panel layout, and thermocouple locations, for the testing performed in the Examples.

FIG. 4 shows volume shrinkage data for a gypsum panel core containing no fire-resistant additive.

FIG. 5 shows a TGA thermograph for a gypsum panel with no fire-resistant additive.

FIG. 6 shows differences in heat-induced shrinkage profiles in gypsum panels with the first and/or second additive packages of the invention.

FIGS. 7A-7M show optical images from the boards tested in the Examples.

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 8-10%, 5.1%-9.9%, and 5.01%-9.99%. Similarly, where a list is presented, unless stated otherwise, it is to be understood that each individual element of that list, and every combination of components of that list, is a separate embodiment. For example, “1, 2, 3, 4, and 5” encompasses, among numerous embodiments, 1:2:3:1 and 2:3 and 5:1, 3, and 5; and 1, 2, 4, and 5. All ranges are inclusive of their endpoints unless otherwise stated.

As used herein, “about” means within a statistically meaningful range of a value or values such as a stated concentration, length, molecular weight, pH, sequence identity, time frame, temperature or volume. Such a value or range can be within an order of magnitude, typically within 20%, more typically within 10%, and even more typically within 5% of a given value or range. The allowable variation encompassed by “about” will depend upon the particular system under study, and can be readily appreciated by one of skill in the art.

As used herein, the term “slate coat” refers to a gypsum slurry having a higher wet density than the remainder of the gypsum slurry that forms the gypsum core. In some embodiments, the slate coat is formed from a slurry which lacks a foaming agent, but is otherwise identical to the slurry used to form the gypsum core.

As used herein, “msf” refers to 1,000 square feet.

As used herein, “chalcogenide” refers to any compound comprising a chalcogen anion. “Chalcogen” refers to any element in Group VIA of the periodic table, including, but not limited to, oxygen, sulfur, selenium, and tellurium.

As used herein, “transition metal” refers to an element from Groups IB-VIIIB of the periodic table. Non-limiting examples include scandium, titanium, vanadium, chromium, manganese, iron, cobalt, nickel, copper, zinc, yttrium, zirconium, niobium, molybdenum, ruthenium, rhodium, palladium, silver, cadmium, hafnium, tantalum, tungsten, rhenium, osmium, iridium, platinum, gold, and mercury. A “transition metal chalcogenide” refers to any compound comprising at least one transition metal atom and at least one chalcogenide atom.

As used herein, “expandable carbon material” includes expandable graphite, expandable multilayer graphene, and expandable carbon nanotubes.

Gypsum panels and systems of panels, and methods for their manufacture, are provided herein. The panels comprise two different classes of additives, and exhibit improved fire-resistance to an unexpected degree, due to the synergy

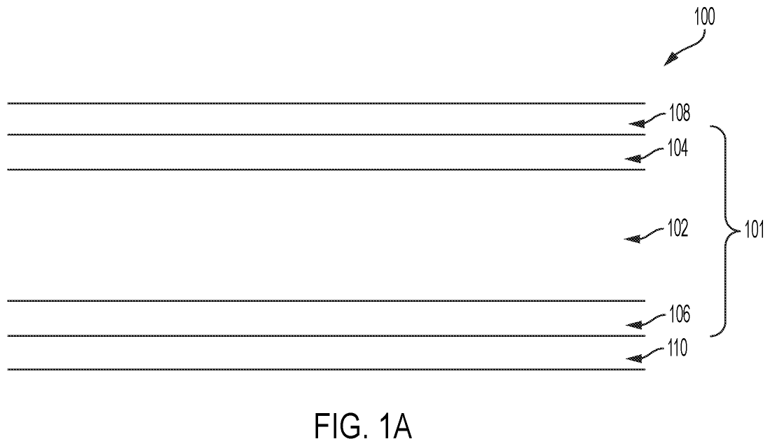

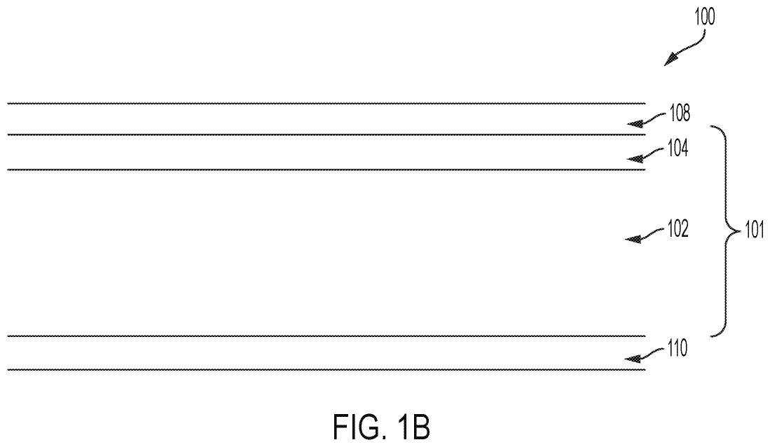

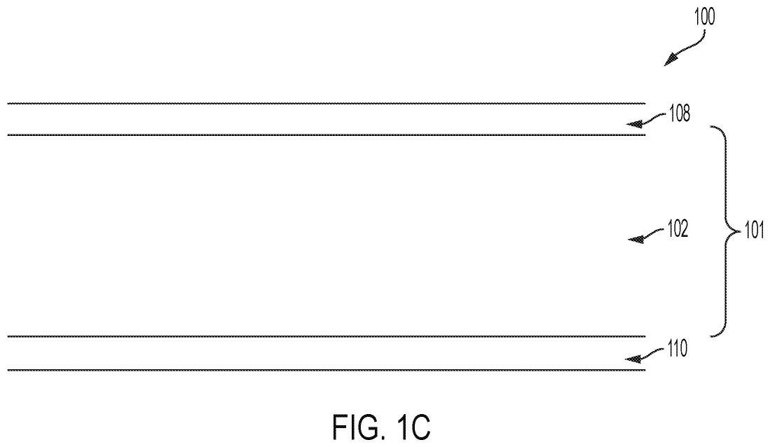

In certain embodiments, as shown in FIG. 1A, a gypsum panel 100 includes a gypsum core 102, and two slate coat layers 104, 106. The second slate coat layer 106 is present on a face of the gypsum core 102 opposite the first slate coat layer 104. The two slate coat layers 104, 106 and the gypsum core 102, collectively, may be referred to as the gypsum layers 101, as the slate coat layers 104, 106 are also made of gypsum. The gypsum panel also comprises two face layers 108, 110 that are associated with the gypsum panel 101. The second face layer 110 is present on a face of the gypsum panel opposite the first face layer 108. In some embodiments, one or both of the face layers 108, 110 may have a coating disposed on one or both surfaces thereof, prior to combination with the gypsum slurry, or, for external surface coatings, after combination with the gypsum slurry.

Another embodiment, shown in FIG. 1B, is identical to that depicted in FIG. 1A, but without a second slate coat layer 106. The gypsum core 102 is directly adjacent to the second face layer 110. Thus, the gypsum layers 101 include only the gypsum core 102 and the first slate coat layer 104.

Another embodiment, shown in FIG. 1C, is identical to that depicted in FIG. 1A, but without any slate coat layers. The gypsum core 102 is directly adjacent to both the first face layer 108 and the second face layer 110. Thus, the only component in the gypsum layers 101 is the gypsum core 102.

During manufacturing, gypsum slurries are be deposited on the uncoated surface of a face material, such as a paper sheet or fiberglass mat (which may be pre-coated offline or online), and set to form a gypsum core of the panel. The gypsum slurries may adhere to a paper facing material or penetrate some portion of the thickness of the fiberglass mat, and provide a mechanical bond for the panel. In an embodiment, there are three gypsum slurry layers applied, in order, to form the embodiment depicted in FIG. 1A: 1) a first slate coat slurry; 2) a gypsum core layer slurry; and 3) a second slate coat slurry. In an embodiment, the first and the second slate coat slurries are identical. In an embodiment, there are two gypsum slurry layers applied, in order, to form the embodiment depicted in FIG. 1B: 1) a first slate coat slurry; and 2) a gypsum core layer slurry. Following the deposition of the gypsum slurry layers, a second face layer is laid on top of the slurries, prior to curing.

As used herein, the term “slate coat” refers to a gypsum slurry having a higher wet density than the remainder of the gypsum slurry that forms the gypsum core. In some embodiments, the slate coat is formed from a slurry which lacks a foaming agent, but is otherwise identical to the slurry used to form the gypsum core. In some embodiments, the slate coat is formed from a slurry which lacks a foaming agent, but is otherwise identical to the slurry used to form the gypsum core.

While this disclosure is generally directed to gypsum panels, it should be understood that other cementitious panel core materials comprising the first and second additive packages are also intended to fall within the scope of the present disclosure. For example, cementitious panel core materials such as those including magnesium oxide or aluminosilicate may be substituted for the gypsum of the embodiments disclosed herein, to achieve similar results. Similarly, composite panels comprising a cementitious layer, in which the cementitious layer comprises the first and second additive packages, are also within the scope of the present disclosure.

The face layers may be made of any suitable material used as face layers in gypsum panels known in the art. In some embodiments, the face layers are paper facing materials or fiberglass mats. In other embodiments, other fibrous mat materials, may be used. In certain embodiments, the face layer is a nonwoven fibrous mat formed of fiber material that is capable of forming a strong bond with the material of the building panel core through a mechanical-like interlocking between the interstices of the fibrous mat and portions of the core material. Examples of fiber materials for use in the nonwoven mats include mineral-type materials such as glass fibers, synthetic resin fibers, and mixtures or blends thereof. Both chopped strands and continuous strands may be used. Generally, when the face layer is a glass mat, the glass mat will comprise glass fibers, a resin binder, and a mat coating.

### Methods and Compositions

Methods of making gypsum panels containing the first and second additive classes are provided. In particular, these methods may include forming a gypsum slurry by combining stucco, water, the first additive package, and the second additive package, and setting the gypsum slurry to form a gypsum layer of said gypsum panel.

The first and second additive packages are present in at least one gypsum layer or slurry. In a preferred embodiment, they are present in each gypsum layer or slurry (i.e., they are present in the gypsum core, and each slate coat layer, if present).

In embodiments comprising a first face layer and a second face layer, the face layers do not need to be identical. For example, in an embodiment where both face layers are glass mats, one glass mat may have a binder comprising formaldehyde, while the other glass mat may comprise a formaldehyde-free binder. The components and concentrations thereof in each of the face layers are independent of each other.

In embodiments, gypsum slurries are prepared with a stucco to water ratio of 100 parts of stucco to 50-100 parts of water.

In certain embodiments, the gypsum slurries of the present disclosure, used to form the gypsum core or the slate coat layers, further contain one or more ingredients or additives to achieve the desired board properties. Various additives are discussed herein and may be used in any combination. In particular, suitable additives may include, but are not limited to, one or more of starch, fiberglass, dispersants, ball mill accelerators, retarders, potash, polyphosphates, and polymer binders.

For example, a suitable polyphosphate may be contained in a gypsum slurry. For example, the polyphosphate may be sodium trimetaphosphate (STMP), sodium hexametaphosphate (SHMP), ammonium polyphosphate (APP). Other suitable phosphate salts may also be used and include other metaphosphate, polyphosphate, and pyrophosphate salts, such as ammonium trimetaphosphate, potassium trimetaphosphate, lithium trimetaphosphate, calcium trimetaphosphate, sodium calcium trimetaphosphate, aluminum trimetaphosphate; ammonium, lithium, or potassium hexametaphosphates; sodium tripolyphosphate, potassium tripolyphosphate, sodium and potassium tripolyphosphate; calcium pyrophosphate, tetrapotassium pyrophosphate, and/or tetrasodium pyrophosphate.

In certain embodiments, a polyphosphate is present in the relevant gypsum layer or slurry in an amount of about 0.01 percent to about 1 percent, by weight. In certain embodiments, the polyphosphate is present in the relevant gypsum layer or slurry in an amount of about 0.01 percent to about 0.5 percent, by weight. In some embodiments, the polyphosphate is present in the relevant gypsum layer or slurry in an amount of about 0.05 percent to about 0.2 percent, by weight. In some embodiments, the polyphosphate is present in the relevant gypsum layer or slurry in an amount of about 1 lb/msf to about 50 lb/msf, for a gypsum panel having a thickness of about ¼ inch to about 1 inch.

For example, a suitable polymer binder, such as an organic polymer binder may be contained in a gypsum slurry. Suitable polymer binders may include polymeric emulsions and resins, e.g., acrylics, siloxane, silicone, styrene-butadiene copolymers, polyethylene-vinyl acetate, polyvinyl alcohol, polyvinyl chloride (PVC), polyurethane, urea-formaldehyde resin, phenolics resin, polyvinyl butyryl, styrene-acrylic copolymers, styrene-vinyl-acrylic copolymers, styrene-maleic anhydride copolymers. In some embodiments, the binders may include UV curable monomers and polymers (e.g., epoxy acrylate, urethane acrylate, polyester acrylate). For example, on a dry basis, the polymer binder content in the relevant gypsum layer or slurry may be between 1 lb/msf to 50 lb/msf, for a gypsum panel having a thickness of about ¼ inch to 1 inch.

In certain embodiments, a polymer binder is present in the relevant gypsum layer or slurry in an amount of about 0.01 percent to about 1 percent, by weight. In certain embodiments, the polymer binder is present in the relevant gypsum layer or slurry in an amount of about 0.01 percent to about 0.5 percent, by weight. In some embodiments, the polymer binder is present in the relevant gypsum layer or slurry in an amount of about 0.05 percent to about 0.2 percent, by weight. In some embodiments, the polymer binder is present in the relevant gypsum layer or slurry in an amount of about 1 lb/msf to about 50 lb/msf, for a gypsum panel having a thickness of about ¼ inch to about 1 inch.

In certain embodiments, each of the slate coat layers is deposited in an amount of from about 5 percent to about 20 percent, by weight, of the gypsum layers. This would mean that the gypsum core layer comprises about 80 to about 95 percent of the total weight of the gypsum layers, when one slate coat layer is present, and about 60 to about 90 percent of the total weight of the gypsum layers, when two slate coat layers are present. The gypsum slurries may be deposited by any suitable means, such as roll coating.

In certain embodiments, a gypsum layer or slurry contains one or more additional agents to enhance its performance, such as, but not limited to, wetting agents, moisture resistance agents, fillers, accelerators, set retarders, foaming agents, polyphosphates, and dispersing agents. Various example uses of such further additives will now be described.

In certain embodiments, a wetting agent is selected from a group consisting of surfactants, superplasticisers, dispersants, agents containing surfactants, agents containing superplasticisers, agents containing dispersants, and combinations thereof. For example, suitable superplasticisers include Melflux 2651 F and 4930F, commercially available from BASF Corporation. In certain embodiments, the wetting agent is a surfactant having a boiling point of 200° C. or lower. In some embodiments, the surfactant has a boiling point of 150° C. or lower. In some embodiments, the surfactant has a boiling point of 110° C. or lower. For example, the surfactant may be a multifunctional agent based on acetylenic chemistry or an ethoxylated low-foam agent.

In certain embodiments, a surfactant is present in the relevant gypsum layer or slurry in an amount of about 0.01 percent to about 1 percent, by weight. In certain embodiments, the surfactant is present in the relevant gypsum layer or slurry in an amount of about 0.01 percent to about 0.5 percent, by weight. In some embodiments, the surfactant is present in the relevant gypsum layer or slurry in an amount of about 0.05 percent to about 0.2 percent, by weight. In some embodiments, the surfactant is present in the relevant gypsum layer or slurry in an amount of about 1 lb/msf to about 50 lb/msf, for a gypsum panel having a thickness of about ¼ inch to about 1 inch.

Suitable surfactants and other wetting agents may be selected from non-ionic, anionic, cationic, or zwitterionic compounds, such as alkyl sulfates, ammonium lauryl sulfate, sodium lauryl sulfate, alkyl-ether sulfates, sodium laureth sulfate, sodium myreth sulfate, docusates, dioctyl sodium sulfosuccinate, perfluorooctanesulfonate, perfluorobutanesulfonate, linear alkylbenzene sulfonates, alkyl-aryl ether phosphates, alkyl ether phosphate, alkyl carboxylates, sodium stearate, sodium lauroyl sarcosinate, carboxylate-based fluorosurfactants, perfluorononanoate, perfluorooctanoate, amines, octenidine dihydrochloride, alkyltrimethylammonium salts, cetyl trimethylammonium bromide, cetyl trimethylammonium chloride, cetylpyridinium chloride, benzalkonium chloride, benzethonium chloride, 5-Bromo-5-nitro-1,3-dioxane, dimethyldioctadecylammonium chloride, cetrimonium bromide, dioctadecyldimethylammonium bromide, sultaines, cocamidopropyl hydroxysultaine, betaines, cocamidopropyl betaine, phospholipids phosphatidylserine, phosphatidylethanolamine, phosphatidylcholine, sphingomyelins, fatty alcohols, cetyl alcohol, stearyl alcohol, cetostearyl alcohol, stearyl alcohols. oleyl alcohol, polyoxyethylene glycol alkyl ethers, octaethylene glycol monododecyl ether, pentaethylene glycol monododecyl ether, polyoxypropylene glycol alkyl ethers, glucoside alkyl ethers, polyoxyethylene glycol octylphenol ethers, polyoxyethylene glycol alkylphenol ethers, glycerol alkyl esters, polyoxyethylene glycol sorbitan alkyl esters, sorbitan alkyl esters, cocamide MEA, cocamide DEA, dodecyldimethylamine oxide, polyethoxylated tallow amine, and block copolymers of polyethylene glycol and polypropylene glycol. For example, suitable surfactants include Surfynol 61, commercially available from Air Products and Chemicals, Inc. (Allentown, PA).

In certain embodiments, a moisture resistance or hydrophobizing agent is provided in the gypsum slurry or layers thereof to impart desired moisture resistance and/or processing properties to the panel. For example, the moisture resistance or hydrophobizing agent may include a wax, wax emulsions or co-emulsions, silicone, siloxane, siliconate, or any combination thereof. In certain embodiments, a moisture resistance or hydrophobizing agent is present in the relevant gypsum layer or slurry in an amount of about 0.01 percent to about 1 percent, by weight. In certain embodiments, the moisture resistance or hydrophobizing agent is present in the relevant gypsum layer or slurry in an amount of about 0.01 percent to about 0.5 percent, by weight. In some embodiments, the moisture resistance or hydrophobizing agent is present in the relevant gypsum layer or slurry in an amount of about 0.05 percent to about 0.2 percent, by weight. In some embodiments, the moisture resistance or hydrophobizing agent is present in the relevant gypsum layer or slurry in an amount of about 1 lb/msf to about 50 lb/msf, for a gypsum panel having a thickness of about ¼ inch to about 1 inch.

In certain embodiments, the gypsum slurry (or one or more layers thereof) is substantially free of foam, honeycomb, excess water, and micelle formations. As used herein, the term “substantially free” refers to the slurry containing lower than an amount of these materials that would materially affect the performance of the panel. That is, these materials are not present in the slurry in an amount that would result in the formation of pathways for liquid water in the glass mat of a set panel, when under pressure.

In certain embodiments, a gypsum slurry layer, and particularly a slate coat layer, may be deposited on a horizontally oriented moving web of facer material, such as pre-coated fibrous mat or paper facing material. A second coated or uncoated web of facer material may be deposited onto the surface of the gypsum slurries (particularly a second slate coat slurry) opposite the first web of facer material, e.g., a non-coated surface of the second web of facer material contacts the gypsum slurry layer. In some embodiments, a moving web of a facer material may be placed on the upper free surface of the gypsum slurry. Thus, the gypsum layers may be sandwiched between two facer materials, none, one or both having a coating. In certain embodiments, allowing the gypsum layer slurries and/or coating to set includes curing, drying, such as in an oven or by another suitable drying mechanism, or allowing the material(s) to set at room temperature (i.e., to self-harden).

A barrier coating may be applied to both face layers, prior to or after drying of the face layers. In some embodiments, the glass mats are pre-coated when they are associated with the slate coat slurry. In some embodiments, depositing a barrier coating onto the second surface of the first coated face layer occurs after setting the first gypsum slurry to form a slate core layer. In some embodiments, the slate coat layer coated with the barrier coating is cured, dried, such as in an oven or by another suitable drying mechanism, or the materials are allowed to set at room temperature. In some embodiment, infrared heating is used to flash off water and dry the barrier coating.

Suitable coating materials (i.e., the precursor to the dried mat coating) may contain at least one suitable polymer binder. Suitable polymer binders may be selected from polymeric emulsions and resins, e.g. acrylics, siloxane, silicone, styrene-butadiene copolymers, polyethylene-vinyl acetate, polyvinyl alcohol, polyvinyl chloride (PVC), polyurethane, urea-formaldehyde resin, phenolics resin, polyvinyl butyryl, styrene-acrylic copolymers, styrene-vinyl-acrylic copolymers, styrene-maleic anhydride copolymers. In some embodiments, the polymer binder is an acrylic latex or a polystyrene latex. In some embodiments, the polymer binder is hydrophobic. In certain embodiments, the binder includes UV curable monomers and/or polymers (e.g. epoxy acrylate, urethane acrylate, polyester acrylate). In certain embodiments, the mat coating contains the polymer binder in an amount of from about 5 percent to about 75 percent, by weight, on a dry basis.

Examples of suitable polymer binders that may be used in the continuous barrier coatings described herein include SNAP 720, commercially available from Arkema Coating Resins, which is a structured nano-particle acrylic polymer containing 100% acrylic latex and 49% solids by weight, with a 0.08 micron particle size; SNAP 728, commercially available from Arkema Coating Resins, which is a structured nano-acrylic polymer containing 100% acrylic latex and 49% solids by weight, with a 0.1 micron particle size; and NEOCAR 820, commercially available from Arkema Coating Resins, which is a hydrophobic modified acrylic latex containing 45% solids by weight, with a 0.07 micron particle size.

In certain embodiments, the mat coating also contains one or more inorganic fillers. For example, the inorganic filler may be calcium carbonate or another suitable filler known in the industry. In certain embodiments, the filler is an inorganic mineral filler, such as ground limestone (calcium carbonate), clay, mica, gypsum (calcium sulfate dihydrate), aluminum trihydrate (ATH), antimony oxide, sodium-potassium alumina silicates, pyrophyllite, microcrystalline silica, and talc (magnesium silicate). In certain embodiments, the filler may inherently contain a naturally occurring inorganic adhesive binder. For example, the filler may be limestone containing quicklime (CaO), clay containing calcium silicate, sand containing calcium silicate, aluminum trihydrate containing aluminum hydroxide, cementitious fly ash, or magnesium oxide containing either the sulfate or chloride of magnesium, or both. In certain embodiments, the filler may include an inorganic adhesive binder as a constituent, cure by hydration, and act as a flame suppressant. For example, the filler may be aluminum trihydrate (ATH), calcium sulfate (gypsum), and the oxychloride and oxysulfate of magnesium. For example, fillers may include MINEX 7, commercially available from the Cary Company (Addison, IL); IMSIL A-10, commercially available from the Cary Company; and TALCRON MP 44-26, commercially available from Specialty Minerals Inc. (Dillon, MT). The filler may be in a particulate form. For example, the filler may have a particle size such that at least 95% of the particles pass through a 100 mesh wire screen.

In certain embodiments, the precursor material that forms the mat coating also contains water. For example, the coating material may contain the polymer binder in an amount of from about 35 percent to about 80 percent, by weight, and water in an amount of from about 20 percent to about 30 percent, by weight. In embodiments containing the filler, the continuous barrier coating material may also contain an inorganic filler in an amount of from about 35 percent to about 80 percent, by weight. In some embodiments, the polymer binder and the inorganic filler are present in amounts of within 5 percent, by weight, of each other. For example, the polymer binder and filler may be present in a ratio of approximately 1:1.

In some embodiments, the mat coating also includes water and/or other optional ingredients such as colorants (e.g., dyes or pigments), transfer agents, thickeners or rheological control agents, surfactants, ammonia compositions, defoamers, dispersants, biocides, UV absorbers, and preservatives. Thickeners may include hydroxyethyl cellulose; hydrophobically modified ethylene oxide urethane; processed attapulgite, a hydrated magnesium aluminosilicate; and other thickeners known to those of ordinary skill in the art. For example, thickeners may include CELLOSIZE QP-09-L and ACRYSOL RM-2020NPR, commercially available from Dow Chemical Company (Philadelphia, Pa.); and ATTAGEL 50, commercially available from BASF Corporation (Florham Park, N.J.). Surfactants may include sodium polyacrylate dispersants, ethoxylated nonionic compounds, and other surfactants known to those of ordinary skill in the art. For example, surfactants may include HYDROPALAT 44, commercially available from BASF Corporation; and DYNOL 607, commercially available from Air Products (Allentown, Pa.). Defoamers may include multi-hydrophobe blend defoamers and other defoamers known to those of ordinary skill in the art. For example, defoamers may include FOAMASTER SA-3, commercially available from BASF Corporation. Ammonia compositions may include ammonium hydroxide, for example, AQUA AMMONIA 26 BE, commercially available from Tanner Industries, Inc. (Southampton, Pa.). Biocides may include broad-spectrum microbicides that prohibit bacteria and fungi growth, antimicrobials such as those based on the active diiodomethyl-p-tolylsulfone, and other compounds known to those of ordinary skill in the art. For example, biocides may include KATHON LX 1.5%, commercially available from Dow Chemical Company, POLYPHASE 663, commercially available from Troy Corporation (Newark, N.J.), and AMICAL Flowable, commercially available from Dow Chemical Company. Biocides may also act as preservatives. UV absorbers may include encapsulated hydroxyphenyl-triazine compositions and other compounds known to those of ordinary skill in the art, for example, TINUVIN 477DW, commercially available from BASF Corporation. Transfer agents such as polyvinyl alcohol (PVA) and other compounds known to those of ordinary skill in the art may also be included in the coating composition.

### Panels and Systems

Gypsum panels having improved fire resistance and/or physical properties may be made by any of the methods described herein. For example, a gypsum panel may include a gypsum core containing set gypsum and a colloidal material including colloidal silica, colloidal alumina, or both, wherein the colloidal material is present in the gypsum core in an amount greater than any other component, other than the gypsum. As discussed above, the panels may have a thickness from about ¼ inch to about 1 inch. For example, the panels may have a thickness of from about ½ inch to about ⅝ inch.

In certain embodiments, one or both face layers 108, 110 are a nonwoven fiberglass mat. For example, the glass fibers may have an average diameter of from about 10 to about 17 microns and an average length of from about ¼ inch to about 1 inch. For example, the glass fibers may have an average diameter of 13 microns (i.e., K fibers) and an average length of ¾ inch. In certain embodiments, the nonwoven fiberglass mats have a basis weight of from about 1.5 pounds to about 6.0 pounds per 100 square feet of the mat, such as from about 1.5 pounds to about 3.5 pounds per 100 square feet of the mat. The mats may each have a thickness of from about 20 mils to about 35 mils. The fibers may be bonded together to form a unitary mat structure by a suitable adhesive. For example, the adhesive may be a urea-formaldehyde resin adhesive, optionally modified with a thermoplastic extender or cross-linker, such as an acrylic cross-linker, or an acrylate adhesive resin. In other embodiments, the mat facer may be a suitable paper facer material.

In some embodiments, the gypsum core 102 is present in an amount from about 5 percent to about 20 percent, by weight, of the gypsum layers 101.

In certain embodiments, one or more of the gypsum layers 101 also include reinforcing fibers, such as chopped fiberglass fibers or particles. In one embodiment, the gypsum core contains about 1 pound to about 20 pounds of reinforcing fibers per 1000 square feet of panel. For example, the gypsum core, or any layer(s) thereof, may include up to about 6 pounds of reinforcing fibers per 1000 square feet of panel. For example, the gypsum core, or a slate coat layer, may include about 3 pounds of reinforcing fibers per 1000 square feet of panel. The reinforcing fibers may have a diameter between about 10 and about 17 microns and have a length between about 5 and about 18 millimeters.

An embodiment of the invention is a composition comprising:
a) calcium sulfate dihydrate;
b) a first additive package that expands when heated from a first temperature to a second temperature; wherein the second temperature is greater than the first temperature; wherein the first temperature is ≥70° C.; and wherein the second temperature is ≤1100° C.; and
c) a second additive package that improves the structural stability of the composition when exposed to a temperature≥800° C. compared to a control composition containing calcium sulfate dihydrate and the first additive package having an identical calcium sulfate dihydrate:first additive package weight ratio but without the second additive package.

In an embodiment, the first temperature is ≥400° C. In a further embodiment, the first temperature is ≥800° C. In an embodiment, the first temperature is greater than or about 70, 75, 80, 85, 90, 95, 100, 110, 120, 130, 140, 150, 200, 250, 300, 350, 400, 450, 500, 550, 600, 750, 800, 850, 900, 950, or 1000° C., or a range between any two of these values.

In an embodiment, the second temperature is ≤1000° C. In an embodiment, the second temperature is ≤900° C. In an embodiment, the second temperature is less than or about 150, 155, 160, 165, 170, 175, 180, 185, 190, 195, 200, 250, 300, 350, 400, 450, 500, 550, 600, 750, 800, 850, 900, 950, 1000, 1050, or 1100° C., or a range between any two of these values.

In an embodiment, the difference between the first temperature and the second temperature is at least, at most, or about 50, 100, 150, 200, 250, 300, 350, 400, 450, 500, 550, 600, 750, 800, 850, 900, 950, or 1000° C., or a range between any two of these values.

In an embodiment, the composition comprises the calcium sulfate dihydrate in an amount of 80-99.9 wt %.

In an embodiment, the first additive package expands by a factor of at least 5 when heated from the first temperature to the second temperature. In an embodiment, the first additive package expands by a factor of at least 10, 20, 30, 40, 50, 60, 70, 80, 90, 100, 150, 200, 250, 300, 350, 400, 450, 500, 550, 600, 650, 700, 800, 850, 900, 950, or 1000 when heated from the first temperature to the second temperature.

In an embodiment, the first additive package expands by a factor of 5-1000, 5-950, 5-900, 5-850, 5-800, 5-750, 5-700, 5-650, 5-600, 5-550, 5-500, 5-450, 5-400, 5-350, 5-300, 5-250, 5-200, 5-150, 5-100, 5-95, 5-90, 5-85, 5-75, 5-70, 5-65, 5-60, 5-55, 5-50, 5-45, 5-40, 5-35, 5-30, 5-25, 5-20, or 5-10 when heated from the first temperature to the second temperature.

In an embodiment, the expansion when the first additive package is heated from the first temperature to the second temperature is by a factor of greater than, less than, or about 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000, or any range between two of these values.

In an embodiment, the first additive package has an expansion volume of about 40-300 cm³/g. In an embodiment, the first additive package has an expansion volume of at least, at most, or about 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or 300 cm³/g, or within a range defined by any two of these values.

In an embodiment, the first additive package has an onset temperature of about 70-500° C. In an embodiment, the first additive package has an onset temperature of at least, at most, or about 70, 75, 80, 85, 90, 95, 100, 105, 110, 115, 120, 125, 130, 135, 140, 145, 150, 175, 200, 225, 250, 275, 300, 325, 350, 375, 400, 425, 450, 475, or 500° C., or within a range defined by any two of these values.

In an embodiment, the first additive package comprises at least one selected from expandable graphite, expandable multilayered graphene, expandable multilayered carbon nanotubes, and a hydrated alkali metal metasilicate.

In an embodiment, the hydrated alkali metal metasilicate comprises at least one of sodium, lithium, beryllium and magnesium.

In an embodiment, the first additive package comprises a transition metal chalcogenide.

In an embodiment, the second additive package comprises at least 40 wt. % of one silica-containing mineral; and 0-5 wt. % of a ceramic flux agent.

In an embodiment, the second additive package comprises at least, at most, or about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 60, 61, 62, 63, 64, 65, 66, 67, 68, 69, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt % of one silica-containing material, or a range between any two of these values.

In an embodiment, the silica-containing mineral is selected from the group consisting of montmorillonite, kaolinite, and magnesium aluminum silicates.

In an embodiment, the silica-containing mineral is comprised in a clay. As non-limiting examples, the clay may be selected from the group consisting of bentonite clays (comprised mainly of the clay mineral montmorillonite), attapulgite clays (containing magnesium aluminum silicates), and kaolinitic clays. The kaolinitic clays include, as non-limiting examples, kaolin, ball clay, fireclay, and flint clay.

Other minerals, such as illite, chlorite, kaolinite, and montmorillonite, or clays comprising such minerals, may also be used. Generally, the clays may be utilized in calcined or uncalcined forms.

In an embodiment, the second additive package comprises at least, at most, or about 0.0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt % of a ceramic flux agent, or a range between any two of these values. In a preferred embodiment, the ceramic flux agent is present in an amount of ≤4.0% by weight of the non-intumescent fire-resistant additive. In a more preferred embodiment, the ceramic flux agent is present in an amount of ≤3.0% by weight of the non-intumescent fire-resistant additive. In a more preferred embodiment, the ceramic flux agent is present in an amount of ≤2.0% by weight of the non-intumescent fire-resistant additive. In a more preferred embodiment, the ceramic flux agent is present in an amount of ≤1.0% by weight of the non-intumescent fire-resistant additive. In a more preferred embodiment, the ceramic flux agent is present in an amount of ≤0.5% by weight of the non-intumescent fire-resistant additive. In a more preferred embodiment, the ceramic flux agent is present in an amount of ≤0.1% by weight of the non-intumescent fire-resistant additive. In a more preferred embodiment, the ceramic flux agent is present in an amount of 0% by weight of the non-intumescent fire-resistant additive.

In an embodiment, the ceramic flux agent comprises a compound which includes an element selected from the group consisting of lead, sodium, potassium, boron, lithium, calcium, magnesium, barium, zinc, strontium, and manganese.

In an embodiment, the ceramic flux agent is an oxide.

In an embodiment, the ceramic flux agent is selected from the group consisting of lead oxides; sodium oxide; potassium oxide; boron oxide; lithium oxide; calcium oxide; magnesium oxide; barium oxide, zinc oxide, strontium oxide, and manganese oxides. In embodiments, the lead oxide is lead (II) oxide, lead tetroxide, or lead dioxide. In embodiments, the manganese oxide is manganese (II) oxide, manganese (II,III) oxide, manganese (III) oxide, manganese dioxide, manganese (VI) oxide, or manganese (VII) oxide.

In an embodiment, the expandable graphite comprises synthetic expandable graphite.

In an embodiment, the expandable graphite has an expansion volume of about 40-300 cm³/g. In an embodiment, the expandable graphite has an expansion volume of at least, at most, or about 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or 300 cm³/g, or within a range defined by any two of these values.

In an embodiment, the expandable graphite has an onset temperature of about 70-500° C. In an embodiment, the expandable graphite has an onset temperature of at least, at most, or about 70, 75, 80, 85, 90, 95, 100, 105, 110, 115, 120, 125, 130, 135, 140, 145, 150, 175, 200, 225, 250, 275, 300, 325, 350, 375, 400, 425, 450, 475, or 500° C., or within a range defined by any two of these values.

In an embodiment, the weight ratio of the first additive package to the second additive package is selected from:
a) ≥0.1:1 to ≤10:1;
b) ≥1:1 to ≤10:1; and
c) ≥1:1 to ≤1:2.

In an embodiment, the weight ratio of the first additive package to the second additive package is greater than, less than, or about 0.05:1, 0.1:1, 0.2:1, 0.5:1, 1:1, 2:1, 5:1, 10:1, or 20:1, or a range between any two of these values.

In an embodiment, the composition comprises the first additive package in an amount of 0.05-10 wt %. In an embodiment, the composition comprises the first additive package in an amount at least, at most, or equal to 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 wt %, or a range between any two of these values.

In an embodiment, the composition comprises the second additive package in an amount of 0.05-10 wt %. In an embodiment, the composition comprises the second additive package in an amount at least, at most, or equal to 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 wt %, or a range between any two of these values.

In an embodiment, said composition comprises vermiculite in an amount of less than 1 wt %. In an embodiment, said composition comprises vermiculite in an amount of less than 0.1 wt %. In an embodiment, said composition comprises vermiculite in an amount of less than 0.01 wt %. In an embodiment, said composition comprises vermiculite in an amount of less than 0.001 wt %. In an embodiment, said composition does not comprise vermiculite.

An embodiment is a gypsum panel comprising:
a) calcium sulfate dihydrate;
b) a first additive package comprising at least one selected from expandable graphite and hydrated sodium alkali metal metasilicate;
c) a second additive package comprising at least 40 wt. % of one silica-containing mineral; and 0-5 wt. % of a ceramic flux agent.

An embodiment is a gypsum panel comprising one of the above-identified compositions, wherein the gypsum panel comprises a less-dense core layer and at least one more-dense slate coat layer. It is understood that the composition making up the core layer is different from the composition making up the at least one slate coat layer.

In a further embodiment, the sum of the concentrations of the first and second additive packages in the slate coat layer is greater than the sum of the concentrations of the first and second additive packages in the core layer, by wt. %. In an embodiment, the sum of the concentrations of the first and second additive packages in the slate coat layer is greater than the sum of the concentrations of the first and second additive packages in the core layer, by 1-300%, by wt %.

In an embodiment, the concentration of the first additive package is the same in the core layer and in the at least one slate coat layer, by wt %. In an embodiment, concentration of the first additive package is different in the core layer than in the at least one slate coat layer, by wt %. In an embodiment, the concentration of the first additive package is greater in the core layer than in the at least one slate coat layer, by wt %. In an embodiment, the concentration of the first additive package is lower in the core layer than in the at least one slate coat layer, by wt %.

In an embodiment, the concentration of the second additive package is the same in the core layer and in the at least one slate coat layer, by wt %. In an embodiment, concentration of the second additive package is different in the core layer than in the at least one slate coat layer, by wt %. In an embodiment, the concentration of the second additive package is greater in the core layer than in the at least one slate coat layer, by wt %. In an embodiment, the concentration of the second additive package is lower in the core layer than in the at least one slate coat layer, by wt %.

It is understood that when the gypsum panel comprises more than one slate coat layer, the different slate coat layers may have identical or different concentrations of any component therein. For example, in a gypsum panel comprising a core layer, a first slate coat layer, and a second slate coat layer, if the first slate coat layer has a first additive package concentration identical to that of the core layer, the second slate coat layer may have a first additive package concentration that is greater than, less than, or equal to that of the core layer. This also means that different layers may comprise expandable carbon material with different intercalating compounds, so as to provide different expansion properties to each layer.

In an embodiment, the gypsum panel has a thickness of about ¼ inch to about 1 inch.

In an embodiment, the gypsum panel comprises the first additive package in an amount of greater than, less than, or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 60, 61, 62, 63, 64, 65, 66, 67, 68, 69, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 lb/msf, in a gypsum panel having a thickness of about ¼ inch to about 1 inch.

In an embodiment, the gypsum panel comprises the second additive package in an amount of greater than, less than, or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 60, 61, 62, 63, 64, 65, 66, 67, 68, 69, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 lb/msf, in a gypsum panel having a thickness of about ¼ inch to about 1 inch.

In an embodiment, the core layer comprises the first additive package in an amount of greater than, less than, or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 60, 61, 62, 63, 64, 65, 66, 67, 68, 69, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 lb/msf, in a gypsum panel having a thickness of about ¼ inch to about 1 inch.

In an embodiment, the core layer comprises the second additive package in an amount of greater than, less than, or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 60, 61, 62, 63, 64, 65, 66, 67, 68, 69, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 lb/msf, in a gypsum panel having a thickness of about ¼ inch to about 1 inch.

In an embodiment, a slate coat layer comprises the first additive package in an amount of greater than, less than, or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 60, 61, 62, 63, 64, 65, 66, 67, 68, 69, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 l/msf, in a gypsum panel having a thickness of about ¼ inch to about 1 inch.

In an embodiment, a slate coat layer comprises the second additive package in an amount of greater than, less than, or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 60, 61, 62, 63, 64, 65, 66, 67, 68, 69, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 lb/msf, in a gypsum panel having a thickness of about ¼ inch to about 1 inch.

In an embodiment, said gypsum core layer or at least one slate coat layer further comprises starch. In an embodiment, said gypsum core layer or at least one slate coat layer comprises starch in an amount of about 1 lb/msf to about 70 lb/msf, for a gypsum panel having a thickness of about ¼ inch to about 1 inch.

In an embodiment, said gypsum core layer or at least one slate coat layer further comprises a polyphosphate. In an embodiment, said polyphosphate is selected from the group consisting of sodium trimetaphosphate (STMP), sodium hexametaphosphate (SHMP), ammonium polyphosphate (APP), ammonium trimetaphosphate, potassium trimetaphosphate, lithium trimetaphosphate, calcium trimetaphosphate, sodium calcium trimetaphosphate, aluminum trimetaphosphate; ammonium, lithium, or potassium hexametaphosphates; sodium tripolyphosphate, potassium tripolyphosphate, sodium and potassium tripolyphosphate; calcium pyrophosphate, tetrapotassium pyrophosphate, and tetrasodium pyrophosphate.

In an embodiment, said gypsum core layer or at least one slate coat layer further comprises a polymer binder. In an embodiment, said gypsum core layer or at least one slate coat layer comprises said polymer binder in an amount of about 1 lb/msf to about 50 lb/msf, for a gypsum panel having a thickness of about ¼ inch to about 1 inch.

In an embodiment, said polymer binder is selected from the group consisting of acrylics, siloxane, silicone, styrene-butadiene copolymers, polyethylene-vinyl acetate, polyvinyl alcohol, polyvinyl chloride (PVC), polyurethane, urea-formaldehyde resin, phenolics resin, polyvinyl butyryl, styrene-acrylic copolymers, styrene-vinyl-acrylic copolymers, styrene-maleic anhydride copolymers, epoxy acrylates, urethane acrylates, and polyester acrylates.

In an embodiment, said gypsum core layer or at least one slate coat layer further comprises starch. In an embodiment, said gypsum core layer or at least one slate coat layer comprises starch in an amount of about 1 lb/msf to about 70 lb/msf, for a gypsum panel having a thickness of about ¼ inch to about 1 inch.

In an embodiment, said gypsum core layer or at least one slate coat layer further comprises a polyphosphate. In an embodiment, said gypsum core layer or at least one slate coat layer comprises said polyphosphate in an amount of about 1 lb/msf to about 50 lb/msf, for a gypsum panel having a thickness of about ¼ inch to about 1 inch.

In an embodiment, said polyphosphate is selected from the group consisting of sodium trimetaphosphate (STMP), sodium hexametaphosphate (SHMP), ammonium polyphosphate (APP), ammonium trimetaphosphate, potassium trimetaphosphate, lithium trimetaphosphate, calcium trimetaphosphate, sodium calcium trimetaphosphate, aluminum trimetaphosphate; ammonium, lithium, or potassium hexametaphosphates; sodium tripolyphosphate, potassium tripolyphosphate, sodium and potassium tripolyphosphate; calcium pyrophosphate, tetrapotassium pyrophosphate, and tetrasodium pyrophosphate.

In an embodiment, said gypsum core layer or at least one slate coat layer further comprises a polymer binder. In an embodiment, said gypsum core layer or at least one slate coat layer comprises said polymer binder in an amount of about 1 lb/msf to about 50 lb/msf, for a gypsum panel having a thickness of about ¼ inch to about 1 inch.

In an embodiment, said polymer binder is selected from the group consisting of acrylics, siloxane, silicone, styrene-butadiene copolymers, polyethylene-vinyl acetate, polyvinyl alcohol, polyvinyl chloride (PVC), polyurethane, urea-formaldehyde resin, phenolics resin, polyvinyl butyryl, styrene-acrylic copolymers, styrene-vinyl-acrylic copolymers, styrene-maleic anhydride copolymers, epoxy acrylates, urethane acrylates, and polyester acrylates.

In an embodiment, said gypsum core layer or at least one slate coat layer further comprises fiberglass. In an embodiment, said gypsum core layer or at least one slate coat layer comprises said fiberglass in an amount of about 1 lb/msf to about 20 l/msf, for a gypsum panel having a thickness of about ¼ inch to about 1 inch.

In an embodiment, said gypsum core layer or at least one slate coat layer further comprises a surfactant. In an embodiment, said gypsum core layer or at least one slate coat layer comprises said surfactant in an amount of about 1 lb/msf to about 50 lb/msf, for a gypsum panel having a thickness of about ¼ inch to about 1 inch.

In an embodiment, said gypsum core layer or at least one slate coat layer further comprises a moisture resistance or hydrophobizing agent. In an embodiment, said gypsum core layer or at least one slate coat layer comprises said moisture resistance or hydrophobizing agent in an amount of about 1 lb/msf to about 50 lb/msf, for a gypsum panel having a thickness of about ¼ inch to about 1 inch.

In an embodiment, at least one slate coat layer further comprises a defoamer. In an embodiment, said slate coat layer comprises said defoamer in an amount of about 1 lb/msf to about 50 lb/msf, for a gypsum panel having a thickness of about ¼ inch to about 1 inch.

In an embodiment, said gypsum panel comprises vermiculite in an amount of less than 1 lb/msf. In an embodiment, said gypsum panel comprises vermiculite in an amount of less than 0.1 lb/msf. In an embodiment, said gypsum panel comprises vermiculite in an amount of less than 0.01 lb/msf. In an embodiment, said gypsum panel comprises vermiculite in an amount of less than 0.001 lb/msf. In an embodiment, said gypsum panel does not comprise vermiculite.

An embodiment is also a method of making a gypsum panel, comprising:
i) providing from one to three gypsum slurries, each comprising water and a composition as described above;
ii) setting the one to three gypsum slurries on a first face layer to form one to three gypsum layers of the gypsum panel; and
iii) setting a second face layer on top of the one to three gypsum layers.

In an embodiment, in step ii), one gypsum slurry is set on the first face layer, and said gypsum slurry is a gypsum core slurry. In an embodiment, in step ii), two gypsum slurries are set on the first face layer, and wherein said two gypsum slurries comprise a slate coat slurry and a gypsum core slurry. In an embodiment, in step ii), three gypsum slurries are set on the first face layer, and wherein said three gypsum slurries comprise a first slate coat slurry, a gypsum core slurry, and a second slate coat slurry.

It is understood that the composition making up the gypsum core slurry is different from the composition making up the slate coat slurry or slurries. In an embodiment, the composition making up the first slate coat slurry and the composition making up the second slate coat slurry are identical. In an embodiment, the composition making up the first slate coat slurry and the composition making up the second slate coat slurry are different.

The disclosed subject matter is further described in the following non-limiting Examples. It should be understood that these Examples, while indicating preferred embodiments of the subject matter, are given by way of illustration only.

### DISCUSSION AND EXAMPLES

In this invention it is demonstrated that gypsum panels undergo a sequential mechanism of failure during tests that are run per the ASTM E119/UL 263 time-temperature curve. There is a need to incorporate additives that have a synergistic effect and address the deficiencies of the gypsum panel at the multiple stages in the test to achieve robust fire performance. Herein we describe two different classes of materials, their protection mechanisms, their limitations as standalone additives, and their synergistic benefit.

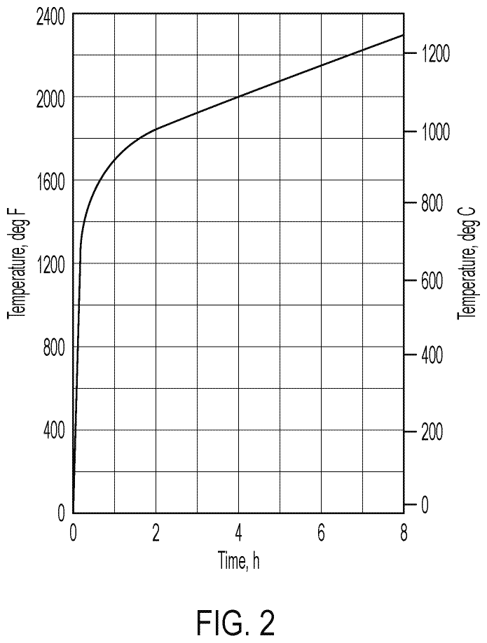

A portion of ASTM E119, showing the time-temperature curve used in the Examples described herein, is provided in FIG. 2.

### Description of the Two Classes of Materials

### First Class of Materials—Early Volumetric Loss Compensation Additives

Fire resistant additives that have intumescent properties like expandable graphite, expandable multilayered graphene, expandable multilayered carbon nanotubes, and hydrated sodium metasilicates, with an expansion onset temperature close to 100° C. compensate for the volume loss in the early portion of the test.

Expandable graphite may include any expandable graphite known in the art, and any property as described herein. For example, the expandable graphite may include NYAGRAPH 20, NYAGRAPH 35, NYAGRAPH 249, NYAGRAPH 249C, NYAGRAPH 251, NYAGRAPH 252, NYAGRAPH 351, or NYAGRAPH 802, commercially available from Nyacol (Ashland, MI); or #3570 Expandable Flake, #3626 Expandable Flake, or #3772 Expandable Flake, commercially available from Asbury Carbons (Detroit, MI).

Without being bound to theory, it is understood that expandable graphite comprises layers of graphite with intercalating compounds found between the layers. At a certain temperature (the “onset temperature”), the intercalating compounds begin to decompose and/or volatize, creating gas, which creates high inter-layer pressure, causing the graphite to expand. The same applies to expandable multilayer graphene and expandable carbon nanotubes.

Intercalating compounds include, but are not limited to, halogens, alkali metals, sulfates, nitrates, nitrites, organic acids (such as adipic acid, formic acid, fumaric acid, glutaric acid, maleic acid, malonic acid, nitric acid, oxalic acid, succinic acid, or sulfuric acid), metal halides (such as aluminum chloride or ferric chloride), sulfides (such as arsenic sulfide or thallium sulfide), and combinations thereof.

It is understood that the expansion properties of expandable graphite, including the onset temperature of expansion, may be modified by changing the identity and the amounts of intercalated compound(s) therein. Accordingly, selection of different forms of expandable graphite will allow for gypsum boards with different rates and onset temperatures of expansion.

Additional details regarding expandable graphite and intercalating agents may be found in U.S. Pat. Nos. 5,173,515, 6,669,919, and 7,118,725, which are hereby incorporated by reference in their entireties.

The expandable graphite may be in the form of particles. The particles may be of any particle size suitable for inclusion in the compositions and gypsum boards of the invention. In certain embodiments, the expandable graphite may have an average particle size of about 30-5000 microns. In an embodiment, the expandable graphite may have an average particle size of at least, at most, or about 30, 50, 100, 200, 300, 400, 500, 600, 700, 800, 900, 1000, 1200, 1400, 1600, 1800, 2000, 2500, 3000, 3500, 4000, 4500, or 5000 microns, or within a range defined by any two of these values. Alternatively, the expandable graphite may be in the form of flakes.

The expandable graphite may comprise the intercalating agent(s) in an amount of about 0.01-10% by weight, relative to the total weight of the expandable graphite. In an embodiment, the expandable graphite comprises the intercalating agent(s) in an amount of at least, at most, or about 0.01, 0.05, 0.1, 0.2, 0.3, 0.4, 0.5, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10% by weight, relative to the total weight of the expandable graphite.

In an embodiment, the expandable graphite may be phosphorus-doped graphite. In an embodiment, the expandable graphite comprises phosphorus in an amount of about 0.01-10% by weight, relative to the total weight of the expandable graphite. In an embodiment, the expandable graphite comprises phosphorus in an amount of at least, at most, or about 0.01, 0.05, 0.1, 0.2, 0.3, 0.4, 0.5, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10% by weight, relative to the total weight of the expandable graphite.

In an embodiment, the expandable graphite is made of at least 3 layers of graphene. In an embodiment, the expandable graphite is made of at least 3, 4, 5, 6, 7, 8, 9, 10, 11, 12, 13, 14, 15, 16, 17, 18, 19, or 20 layers of graphene.

The above discussion of expandable graphite applies to expandable multilayer graphene and expandable carbon nanotubes. Further, any embodiment described herein comprising expandable graphite is also contemplated as comprising, instead, expandable multilayer graphene or expandable carbon nanotubes.

Even at increased addition rates, there is a limit to these additives ability to provide adequate fire protection. Therefore, a second class of materials in necessary to achieve adequate fire protection.

### Second Class of Materials—High Temperature Core Integrity Additives

Fiberglass is a commonly used additive in the gypsum manufacturing industry to provide board strength and integrity. However, E-type glass is the most common and commercially viable form of glass that is used, and it has a softening temperature around 800° C. Enhanced forms of E-glass can be economically manufactured that have even higher softening temperatures, ECR like the OC Advantex ECR fiberglass, but these fiberglass types typically soften around 950° C. The temperature of the ASTM E119/UL 263 curve is around 1000° C.+ for tests that are run on the time temperature curve for 1 hr.+; therefore, fiberglass does not provide resistance to crack propagation, board elongation, and continued shrinkage.

The second class of materials are non-intumescent fire-resistant additives that include silica in an amount of at least 40% by weight of the non-intumescent resistant additive, a ceramic flux agent in a total amount of from 0% by weight to less than or equal to 5% by weight of the non-intumescent fire-resistant additive. Examples include, but are not limited to, clays like kaolin, wollastonite, diatomaceous earth, and colloidal silica. The high silica content and low flux agent composition of these materials allows them to maintain their integrity at higher temperatures and prevent crack propagation, deflection, and board elongation.

### Experimental Setup

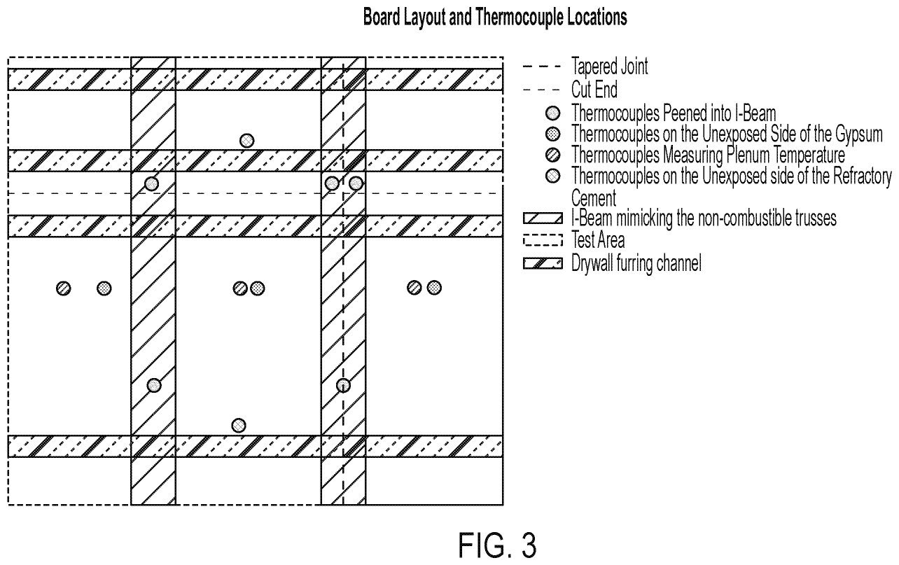

Gypsum panels containing raw materials as well as other typical gypsum panel making additives (fiberglass, starch, dextrose, boric acid, etc.) were run on a medium-scale horizontal furnace with an open area of 5′×5′. The gypsum panels were attached to steel I-beams with hat channel to mimic full scale testing in an assembly with non-combustible framing members like the UL G512 (FIG. 3). Using a high temperature camera, images were taken of the boards in 5 minute time intervals, and then computer vision modeling with MATLABs Image Processing and Computer Vision toolbox was used to correct the images for distortion and ImageJ (National Institutes of Health).

### Example 1: Gypsum Panel Deficiencies During ASTM E119/UL 263 Fire Test

### Stage 1—Volumetric Shrinkage and Mass Loss

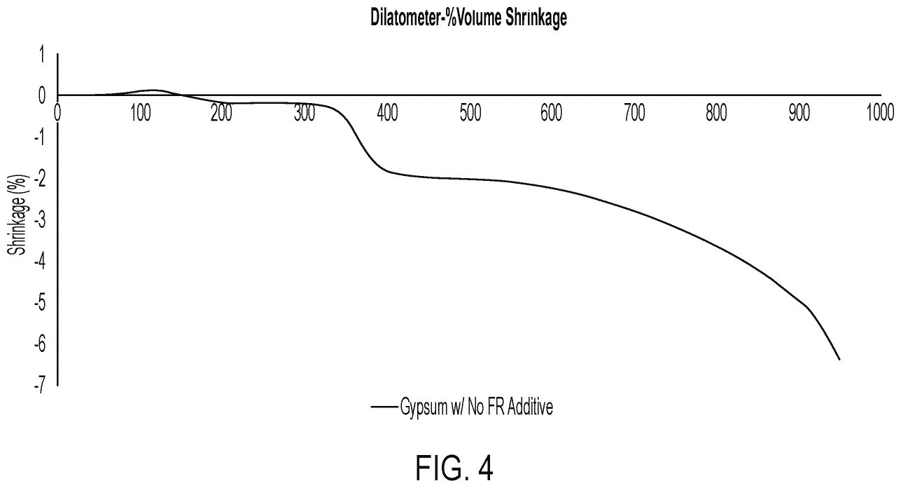

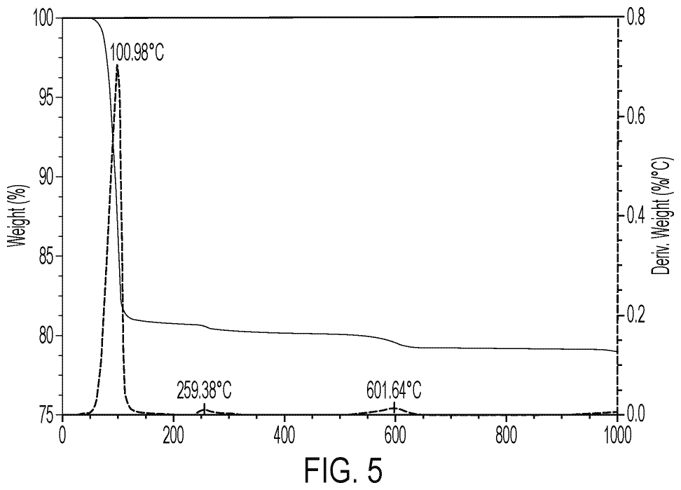

In the early stage of the test (room temperature to ˜200° C. (a temperature at which materials-bound water is theoretically completely vaporized)) the gypsum panel's mechanism of failure is related to the dehydration reaction from calcium sulfate dihydrate to anhydrous calcium sulfate. The volumetric and mass loss of the gypsum is due to the bound water loss. Dilatometer (piece of equipment that measures volume shrinkage on a time and temperature curve) data shows a piece of a gypsum panel's core with no fire-resistant additive (FIG. 4) begins to experience volumetric shrinkage at ˜150° C., close to the onset of bound water loss. This change in the gypsum panel is also demonstrated by the TGA thermogram (FIG. 5) on a piece of gypsum panel with no fire-resistant additive, where ˜20% of the gypsum's mass is lost starting around ˜100° C., close to the onset of bound water loss.

This volumetric shrinkage is detrimental to the performance of an assembly because it exposes the framing members (combustible and non-combustible) directly to heat which can lead to failure during the test. Additionally, gypsum panels are fastened in place in assembly tests and the initial shrinkage creates area of stress concentration and early crack formation. For desirable results in fire tests the rate of volumetric shrinkage as well as the overall volumetric shrinkage needs to be mitigated.

### Stage 2—Crack Propagation and Board Elongation Due to Creep

In the later stages of the test the gypsum panel's mechanism of failure is related to creep. As the test continues, cracks propagate further throughout the core of the gypsum panel and the board begins to deflect and elongate due to creep. The propagation of cracks, deflection, elongation, and continued shrinkage must be slowed or stopped to prevent failure of the board. If effects from the later portion of the test (crack propagation, board elongation, board deflection, and/or continued shrinkage) are addressed by the fire protection mechanism without the rate of shrinkage being slowed, premature failure can still occur.

### Example 2: Testing of First and Second Additive Classes

Similar gypsum panels, but with additives from the first and/or second classes, were tested for their fire resistance. Kaolin clay (high temperature core integrity additive) at a loading level of 40 #/msf is combined with 5 #/msf of expandable graphite with a maximum expansion of 35 cc (NYAGRAPH 35) (Early Volumetric Loss Compensation) are included in a formulation. The expandable graphite has an onset expansion temperature between 180° C. and 200° C. and reaches the maximum expansion rate around 1000° C.

Boards were run on the E119 curve on a furnace with an ˜5 ft×5 ft open area in a steel-based assembly. The board layout was designed to create a joint at the corner of four boards to incorporate a cut end and taper. Failure time is based upon what is outlined in ASTM E119 for failure temperatures. The results are summarized in Table 1, below:

TABLE 1
ASTM E119 fire performance of gypsum
panels containing additives additive

| First additive | Second additive | Failure time |
|---|---|---|
| class component | class component | (minutes) |
| | 40#/msf kaolin | 121.58 |
| | 40#/msf colloidal silica | 118.97 |
| 5#/msf expandable graphite | | 87.33 |
| 5#/msf expandable graphite | 40#/msf kaolin | 178.63 |
| 5#/msf expandable graphite | 20#/msf colloidal silica | 120.50 |

This data shows that as stand-alone additives the 40 #/msf of kaolin, 40 #/msf of colloidal silica, and 5 #/msf of expandable graphite do not perform as well as the formulations that include the two additives.

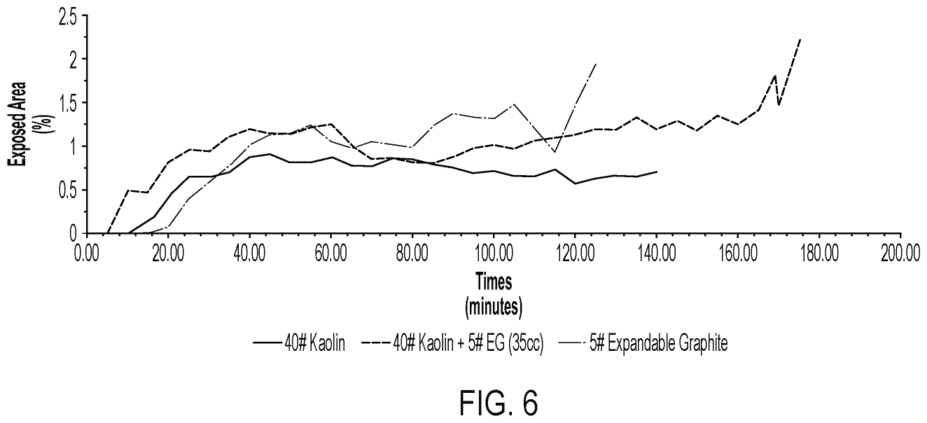

When the shrinkage of boards with the kaolin and expandable graphite is compared to boards with kaolin only or expandable graphite only there is a distinct difference in the profile of exposed area due to board shrinkage (FIG. 6). For the formulations that have expandable graphite alone (yellow) and in conjunction with kaolin (green) a reduction in the overall exposed area can be seen after an initial spike in shrinkage around 60 minutes. This is when tests run per the ASTM E119 time-temperature curve reach a temperature of 927° C. (nearing the maximum expansion temperature of expandable graphite, 1000° C.).

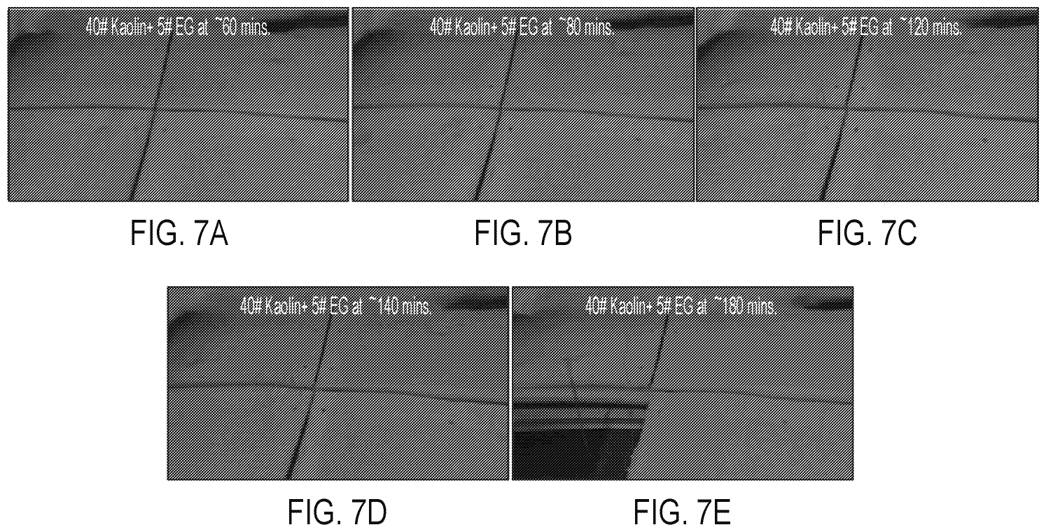

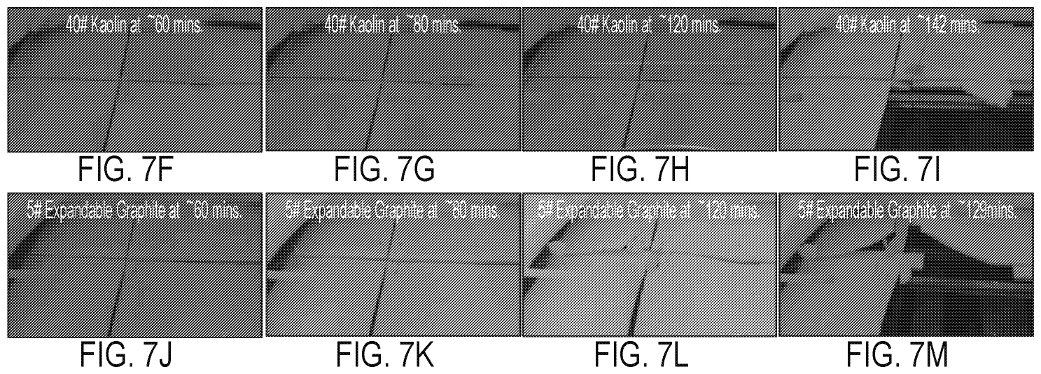

The dual protection mechanism of early shrinkage and high-temperature stability is demonstrated with the data collected from the high temperature camera. When comparing the optical images from the high temperature camera (FIGS. 7A-7M) from boards with 40 #/msf of kaolin and 5 #/msf. of expandable graphite (FIGS. 7A-7E), 40 #/msf. of kaolin (FIGS. 7F-7I), and 5 #/msf. of expandable graphite (FIGS. 7J-7M), the differences in structural integrity of the board at the elevated temperatures are also apparent. At 60 minutes there are already macroscopic cracks in the boards with 5 #of expandable graphite (FIG. 7J) which are not apparent in the other samples at this time (FIGS. 7A and 7F, for the kaolin/expandable graphite and kaolin-containing samples, respectively). By 120 minutes in the test, the boards with only graphite (FIG. 7L) are experiencing more deflection than the boards that contain the second additive package to enhance the high temperature core integrity (FIGS. 7C and 7H).

Many modifications and other embodiments of the subject matter set forth herein will come to mind to one skilled in the art to which the subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation. Each embodiment disclosed herein is contemplated as being applicable to each of the other disclosed embodiments. All combinations and sub-combinations of the various elements described herein are within the scope of the embodiments.

1. A composition comprising:
stucco;
a first additive comprising an intumescent material, wherein the intumescent material expands when heated from a first temperature to a second temperature, wherein the second temperature is greater than the first temperature, wherein the first temperature is ≥400° C., and wherein the second temperature is ≤1100° C.; and
a second additive comprising a non-intumescent material, wherein the composition has improved structural stability when exposed to a temperature≥800° C. compared to a control composition containing the stucco and the first additive having an identical stucco:first additive weight ratio but without the second additive.

2. (canceled)

3. The composition of claim 1, wherein the first temperature is ≥800° C.

4. The composition of claim 1, wherein the second temperature is ≤1000° C.

5. (canceled)

6. The composition of claim 1, wherein the first additive expands by a factor of at least 5 when heated from the first temperature to the second temperature.

7. The composition of claim 6, wherein the first additive expands by a factor of at least 10, 20, 30, 40, 50, 60, 70, 80, 90, 100, 150, 200, 250, 300, 350, 400, 450, 500, 550, 600, 650, 700, 800, 850, 900, 950, or 1000 when heated from the first temperature to the second temperature.

8. The composition of claim 6, wherein the first additive expands by a factor of 5-1000, 5-950, 5-900, 5-850, 5-800, 5-750, 5-700, 5-650, 5-600, 5-550, 5-500, 5-450, 5-400, 5-350, 5-300, 5-250, 5-200, 5-150, 5-100, 5-95, 5-90, 5-85, 5-75, 5-70, 5-65, 5-60, 5-55, 5-50, 5-45, 5-40, 5-35, 5-30, 5-25, 5-20, or 5-10 when heated from the first temperature to the second temperature.

9. The composition of claim 1, wherein the first additive comprises at least one selected from expandable graphite, expandable multilayered graphene, expandable multilayered carbon nanotubes, a hydrated alkali metal metasilicate, and a sheet silicate.

10. (canceled)

11. The composition of claim 1, wherein the first additive further comprises a transition metal chalcogenide.

12. The composition of claim 1, wherein the second additive comprises at least 40 wt. % of one silica-containing mineral; and 0.1-5 wt. % of a ceramic flux agent.

13. (canceled)

14. The composition of claim 12, wherein the ceramic flux agent comprises a compound which includes an element selected from the group consisting of lead, sodium, potassium, boron, lithium, calcium, magnesium, barium, zinc, strontium, and manganese.

15. The composition of claim 12, wherein the ceramic flux agent is an oxide.

16. (canceled)

17. The composition of claim 1, wherein the weight ratio of the first additive to the second additive is selected from:
≥0.1:1 to ≤10:1;
≥1:1 to ≤10:1; and
≥1:1 to ≤1:2.

18. The composition of claim 1, wherein the first additive is present in an amount of 0.05-10 wt. %.

19. The composition of claim 1, wherein the second additive is present in an amount of 0.05-10 wt. %.

20. A gypsum panel comprising:
calcium sulfate dihydrate;
a first additive comprising at least one selected from expandable graphite,
hydrated sodium alkali metal metasilicate, and a sheet silicate; and
a second additive, wherein at least 40 wt. % of the second additive comprises one silica-containing mineral, and wherein from 0.1-5 wt. % of the second additive comprises a ceramic flux agent.

21. The gypsum panel of claim 20, wherein the gypsum panel comprises a less-dense core layer and at least one more-dense slate coat layer.

22. The gypsum panel of claim 21, wherein the sum of the concentrations of the first and second additive in the at least one slate coat layer is greater than the sum of the concentrations of the first and second additive in the gypsum core layer, by wt. %.

23. The gypsum panel of claim 21, wherein the concentration of the first additive is the same in the core layer and in the at least one slate coat layer, by wt %.

24. (canceled)

25. The gypsum panel of claim 21, wherein the concentration of the second additive is the same in the core layer and in the at least one slate coat layer, by wt %.

26-42. (canceled)

43. A method of making a gypsum panel, comprising:
i) providing from one to three gypsum slurries, each comprising water and a composition of claim 1;
ii) setting the one to three gypsum slurries on a first face layer to form one to three gypsum layers of the gypsum panel; and
iii) setting a second face layer on top of the one to three gypsum layers.

44-46. (canceled)
